(19) United States
(12) Patent Application Publication
(10) Pub. No.: US 2014/0161133 A1
(43) Pub. Date: Jun. 12, 2014

(54) METHOD AND APPARATUS FOR IMPROVED QoS ACTIVATION

(71) Applicant: THOMSON LICENSING, Issy de Moulineaux (FR)

(72) Inventors: Casimir Johan CRAWLEY, Carmel, IN (US); Christopher Alan GREEN, Seymour, IN (US)

(21) Appl. No.: 14/100,480

(22) Filed: Dec. 9, 2013

Related U.S. Application Data
(60) Provisional application No. 61/735,630, filed on Dec. 11, 2012.

(51) Int. Cl. H04L 12/725

(52) U.S. Cl. CPC H04L 45/302
USPC 370/401

(57) ABSTRACT

A method of quality of service (QoS) activation of customer premises equipment (CPE) associated with a network, includes activating classifiers associated with a switch port in the CPE, and determining when an associated IP address of the switch port is also activated, wherein the switch port classifier is activated only when the IP address of the switch port is also activated.

### RELATED APPLICATIONS

This invention claims the benefit of U.S. Provisional Patent Application Ser. No. 61/735,630, filed Dec. 11, 2012, entitled METHOD AND APPARATUS FOR IMPROVED QoS ACTIVATION, the teachings of which are specifically set forth herein by reference, and is related to U.S. Utility patent application Ser. No. 13/693,288, filed on Dec. 4, 2012, entitled MECHANISM TO BLOCK WEB SITES USING RETURN TRAFFIC, the teachings of which are also specifically set forth herein by reference.

### FIELD OF THE INVENTION

The present invention relates to customer premise equipment (CPE) which allows users to browse the worldwide web. More specifically, the present invention relates to CPE which allows for improved the Quality of Service (QoS) activation thereby improving the user's experience and the performance of the CPE.

### BACKGROUND OF THE INVENTION

In multicast and broadcast applications, data are transmitted from a server to multiple receivers over wired and/or wireless networks. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

Typically a router connects like and unlike networks such as WANs, MANs, LANs etc. That is, typically, a router is an interface between networks. Typically, a gateway provides an entry or exit into/out of a communications network. The terms router and gateway are used interchangeably herein. A home gateway is simply a gateway device that is used in a home/residential environment. A home gateway as used herein includes the functionality of both a router and a gateway and is used to connect the home network to networks outside the home such as the Internet or cable service provider or satellite provider or other networks provided by a communications provider.

Most CPE contain multiple switch ports, one of which would connect the desired IP host. However, the desired IP host may not remain connected to one particular port. One method ensuring proper classification is activating classifiers for each switch port. However, this approach is expensive and wasteful as only one particular classifier is used at a time. Redundant classifiers also persistently consume memory and CPU resources, which is undesirable. The art has not heretofore solved the problem of efficient QoS activation since prior networks lack the ability to dynamically activate QoS based on device presence, especially when some packets traversing the network contain time sensitive data.

### SUMMARY OF THE INVENTION

The present invention provides methods and apparatus for QoS activation by activating classifiers when their associated IP addresses are also activated. A method of quality of service (QoS) and a CPE activate classifiers associated with a switch port in the CPE, and determine when an associated IP address of the switch port is also activated, wherein the switch port classifier is activated only when the IP address of the switch port is also activated.

The invention will be best understood by reading the following detailed description of the preferred embodiments thereof in conjunction with the drawings which are first described briefly below.

### BRIEF DESCRIPTION OF THE DRAWINGS

The drawings include the following figures briefly described below:

FIG. 1 illustrates a system for communicating between a home and the internet, shown both WAN (internet) and LAN connection through a gateway device in accordance with the principles of the present invention.

FIG. 2 is a block diagram of an exemplary gateway device in accordance with the principles of the present invention.

FIG. 3 is a flow chart of an inventive method for updating device tables.

FIG. 4 is a flow chart of an inventive method for activating classifiers.

### DETAILED DESCRIPTION OF THE PREFERRED EMBODIMENTS

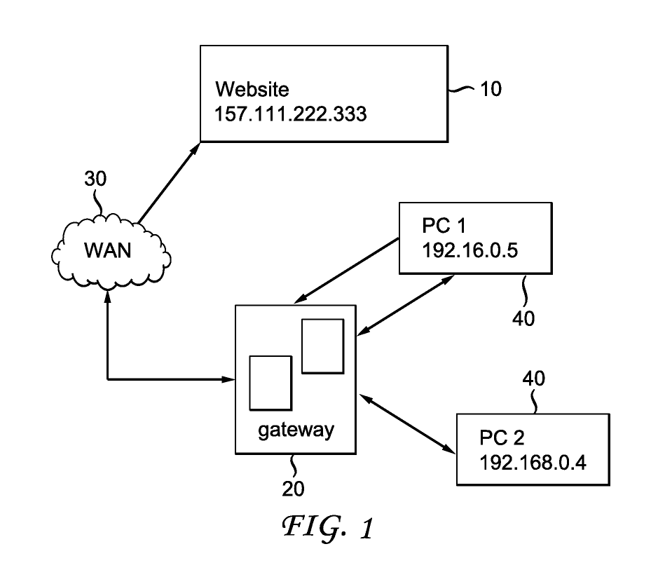

FIG. 1 illustrates a system for communicating between a home and the internet, shown both WAN (internet) and LAN connection through a gateway device in accordance with the principles of the present invention. In FIG. 1 a website, shown at 10, can be contacted by a gateway 20, sometimes called the CPE or just “the device” throughout this text, which communicates through the internet so that a user of the CPE 20 can contact the various websites 10 for downloads, browsing and the like. As will be appreciated by those with skill in the art, the CPE 20 may communicate with the internet through a WAN (or LAN as the terms are used interchangeably herein) shown at 30 so that the home network, in which the CPE 20 is normally placed, may efficiently function to provide access to the users of the home network.

As will be further appreciated, the CPE 20 receives unique IP addresses for the website 10 from the various computers 40 (or other devices in the home network), which themselves are assigned internal IP addresses so that the CPE can manage the home network and the communications throughout. Any number of computers 40 or other devices may reside within the home network and each are thereby assigned IP addresses. As will be appreciated by those skilled in the art, IP networks lacking QoS processes process all of the packets at the same best effort priority level, regardless of traffic differentiation even when some of the packets contain time-sensitive data like, for example, voice or video. This can create delivery problems and can degrade overall system performance, particularly in multiple port CPE networks wherein at least one of the ports connects to a desired IP host but may not remain connected thereto through the same port. Such issues create problems with the user's experience with the CPE and network, and create data delivery and other errors.

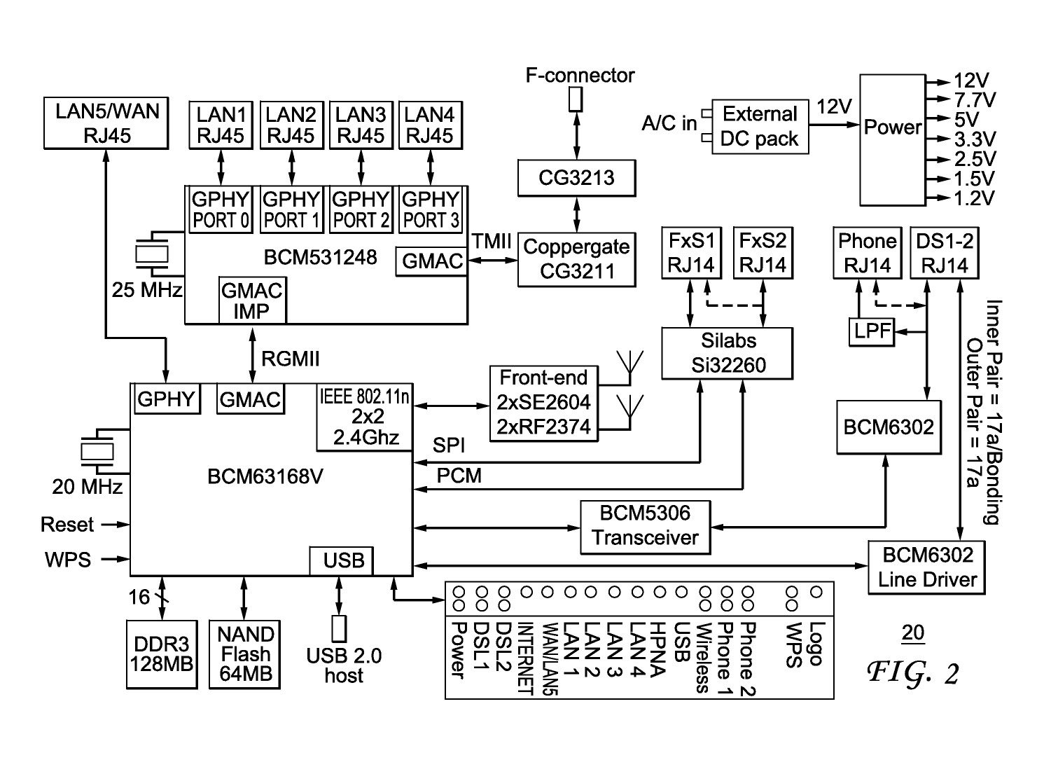

FIG. 2 is a block diagram of an exemplary gateway device 20 in accordance to the principles of the present invention. The main controller is the block labeled BCM63168V. That is, the present invention may be implemented as a program executable on processor/controller BCM6318V. An alternative implementation may be implementation on an application specific integrated circuit (ASIC) or on a field programmable gate array (FPGA) or an equivalent device. The BCM63168V integrated circuit (IC) will receive and process all data traffic from the LAN side and the WAN side and would include any “blocks” associated with incoming LAN traffic (going out to internet) and then also includes the new “blocks” associated with incoming WAN traffic (interception before being transmitted to LAN device).

In FIG. 2 the home gateway 20 includes a front-end for wireless communications and a transceiver (BCM6306) for wired line communications. All reception and transmission signals pass through either the front-end or the transceiver. That is, the means for receiving a requests for access to websites from a user is via either the front-end or the transceiver. The means for determining if the request includes a first domain name is within the controller (BCM63168V) and may be in software (a program) executed on said controller. The means for transmitting the request if the request does not include the first domain name is either the front-end or the transceiver. The means for receiving return traffic in response to the transmitted request is either the front-end or the transceiver. The means for determining if a second domain name in the return traffic matches the first domain name is within the controller (BCM63168V) and may be in software (a program) executed on said controller. The means for allowing access to the website if the first domain name and the second domain name match is within the controller (BCM63168V) and may be in software (a program) executed on said controller. The means for discarding the return traffic if the access is blocked is within the controller (BCM63168V) and may be in software (a program) executed on said controller. The means for determining, based on the first domain name, if the website is blocked is within the controller (BCM63168V) and may be in software (a program) executed on said controller. The means for transmitting the request, if the website in the request is determined not to be blocked, is either the front-end or the transceiver. The means for receiving return traffic in response to the transmitted request is either the front-end or the transceiver. The means for forwarding the return traffic to the user is either the front-end or the transceiver. The means for transmitting a message to the user that access to the requested website is blocked is either the front-end or the transceiver.

As mentioned above, IP networks lacking QoS schemes process all packets at the same best effort priority level. However, traffic differentiation is desirable when some packets contain time-sensitive data like voice or video. QoS classifiers can detect and associate IP packets to a specified priority level. Some QoS classifiers detect and associate such packets based on IP addresses. To solve the aforementioned problems, the invention activates such classifiers when their associated IP addresses are also activated. In order to accomplish this result and to improve the QoS of a CPE in a network, it is preferable to update the device tables of the CPE, and to activate the classifiers associated with the updated device tables.

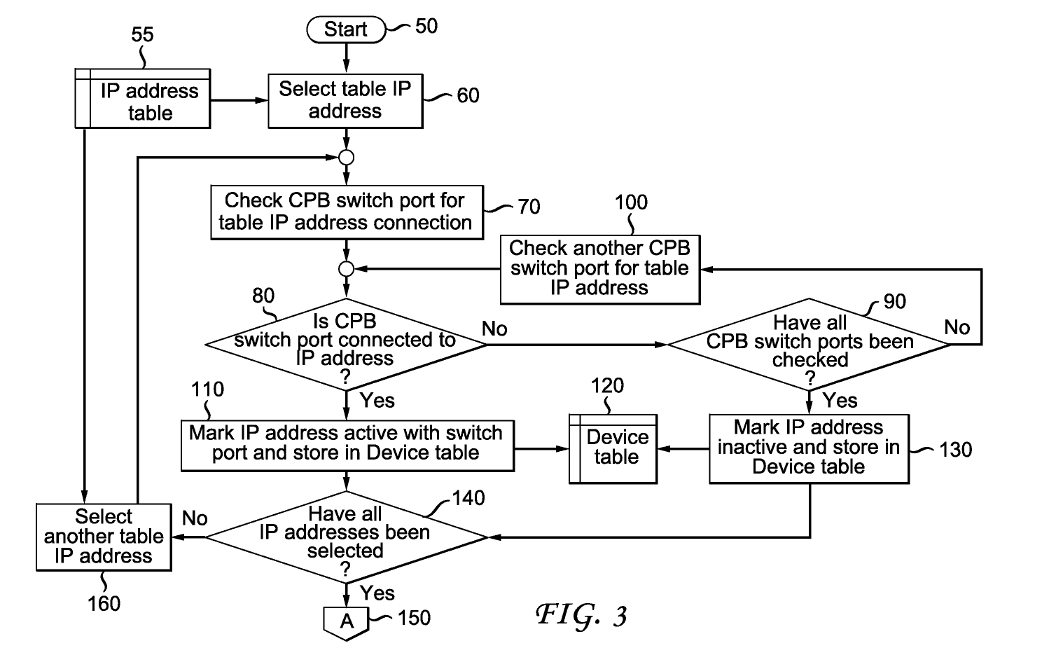

FIG. 3 is a flow chart of an inventive method for updating the device tables of the CPE 20. The method starts at 50, and at 60 an IP table address is selected with input 55 from an IP address table. At 70, the CPE switch port is checked for table IP address connection. At 80, it is determined whether the CPE switch port is connected to the IP address and if so, then at 110 the IP address is marked active with the switch port in device table 120. If not, then at 90 it is determined if all the CPE switch ports have been checked. If not, then at 100 another CPE switch port for the table IP address is checked and the loop is repeated at 80. If so, then at 130 the new CPE IP address so checked is marked inactive and this data is stored in the device table 120.

After 110 and simultaneously with 130 it is determined at 140 whether all IP addresses have been selected. If not, then at 160 another IP address is selected with input from IP address table 55. The loop beginning at 70 is then repeated. If so, at 150, the next aspect of the inventive method goes to 170 (A) wherein the classifiers can be activated as described below.

The following code may be employed to update the device tables as described with respect to FIG. 3:

```
CmsRet UpdateDeviceTable(void *msgHandle, CmsMsgHeader *msg)
{
  CmsRet ret = CMSRET_SUCCESS;
  dtDeviceInfo *deviceInfo;
  int numOfDevices = MAX_DEVICES;
  int inSize = 32;
  int index;
  char buf[sizeof(CmsMsgHeader) + sizeof(DhcpdHostInfoMsgBody)] =
  {0};
  CmsMsgHeader *hdr = (CmsMsgHeader *) buf;
  DhcpdHostInfoMsgBody *body = (DhcpdHostInfoMsgBody *) (hdr+1);
  deviceInfo = getDeviceTable(&numOfDevices, FALSE);
  pingDevices(deviceInfo, numOfDevices);
  if ((ret = cmsLck_acquireLock( )) == CMSRET_SUCCESS)
  {
    // get hosts entries from the MDM
    appendDHCPDevices(deviceInfo, inSize, &numOfDevices);
    cmsLck_releaseLock( );
  }
  // look for devices that have mac entries in the bridge
  appendStaticDevices(deviceInfo, inSize, &numOfDevices);
  hdr->type = CMS_MSG_DHCPD_HOST_RES_INFO;
  hdr->src = EID_TCH_APPS;
  hdr->dst = EID_SSK;
  hdr->flags_event = 1;
  hdr->dataLength = sizeof(DhcpdHostInfoMsgBody);
  body->deleteHost = FALSE;
  body->leaseTimeRemaining = (SINT32) 0;
  snprintf(body->ifName, sizeof(body->ifName), “br0”);
  snprintf(body->hostName, sizeof(body->hostName), “Unknown”);
  snprintf(body->addressSource, sizeof(body->addressSource), MDMVS
  STATIC);
  snprintf(body->interfaceType, sizeof(body->interfaceType),
MDMVS ETHERNET);
  for(index = 0; index < numOfDevices; index++)
  {
    if (deviceInfo[index].active && deviceInfo[index].dirty)
    {
    snprintf(body->ipAddr, sizeof(body->ipAddr),
    deviceInfo[index].ipAddr);
    snprintf(body->macAddr, sizeof(body->macAddr),
    deviceInfo[index].macAddr);
      if (cmsMsg_send(msgHandle, hdr) != CMSRET_SUCCESS)
      {
      cmsLog_error(“could not send host info update”);
      }
      else
      {
      cmsLog_debug(“host info update sent!”);
      }
    }
    }
  mapConnTypes(deviceInfo, numOfDevices);
  updateDeviceList(deviceInfo, numOfDevices);
  freeDeviceTable(deviceInfo);
  ret = app_timer(msgHandle, DEV_TBL_TMR,
  DEV_TBL_TMR_TIMEOUT);
  //printf(“%s( ):%d\n”, _FUNCTION_, _LINE_);
  cmsLog_debug(“%s”, rutTCHGlobals_cmsstrerror(ret));
  return(ret);
}
```

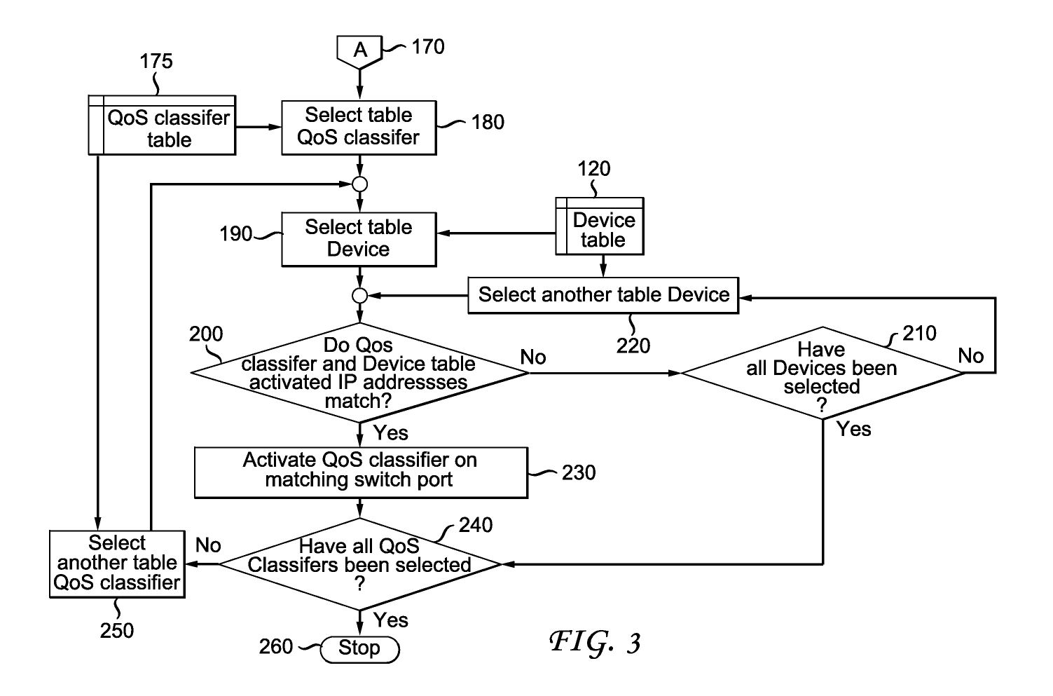

FIG. 4 is a flow chart of an inventive method for activating classifiers as described above preferably after the device tables have been updated. As the device tables have been updated 170 (A) as noted, with a QoS classifier table 175, at 180 the a QoS classifier is selected. At 190 the table device is selected with input about the device from device table 120. It is then determined at 200 whether the QoS classifier and the device table activated IP addresses match. If so, then at 230 the QoS classifier on the matching switch port 230 is activated. If not, then at 210 it is determined whether all of the devices have been selected. If not, then at 220 another device in the device table 120 is selected and the loop repeats at 200. If so, then at 240 it is determined whether all QoS classifiers have been selected. If so, then the QoS classification activation has been completed at 260. If not, then at 250, and with input from the QoS classifier table 175, the loop repeats at 190 with additional device selection from device table 120.

The following code may be employed to activate classifiers as described with respect to FIG. 4:

```
CmsRet ActivateDownstreamADVS_QOS_009(void *msgHandle,
CmsMsgHeader *msg)
{
  CmsRet ret = CMSRET_SUCCESS;
  char l3Ifname[CMS_IFNAME_LENGTH] = {0};
  QosRuleListObject *qrlObj = NULL;
  InstanceIdStack iidStack;
  int i, numOfDevices = MAX_DEVICES;
  dtDeviceInfo *deviceInfo;
  if ((deviceInfo = getDeviceTable(&numOfDevices, FALSE)))
  {
  if (numOfDevices)
  {
    if ((ret = cmsLck_acquireLock( )) == CMSRET_SUCCESS)
    {
    /* Get layer3 interface name */
    if ((ret = dalRt_getActiveDefaultGateway(l3Ifname)) ==
    CMSRET_SUCCESS)
    {
      if (cmsUtl_strcmp(l3Ifname, “&nbsp”))
      {
      INIT_INSTANCE_ID_STACK(&iidStack);
      while ((ret = cmsObj_getNext(MDMOID_QOS_RULE_LIST,
      &iidStack,
          (void **) &qrlObj)) == CMSRET_SUCCESS)
      {
        if (!IS_EMPTY_STRING(qrlObj->destIP) && qrlObj-
>upstream == FALSE)
        {
          for (i = 0; i < numOfDevices; i++)
          {
            if (cmsUtl_strcmp(qrlObj->destIP, deviceInfo[i].ipAddr)
              && deviceInfo[i].active == TRUE)
            {
            ret =
ActivateDownstreamADVS_QOS_006thruADVS_QOS_012(qrlObj,
              deviceInfo[i].connectionType);
            }
          }
          }
          cmsObj_free((void **) &qrlObj);
          if (ret != CMSRET_SUCCESS)
          {
          break;
          }
        }
        if (ret == CMSRET_NO_MORE_INSTANCES)
        {
          ret = CMSRET_SUCCESS;
        }
        }
      }
      cmsLck_releaseLock( );
    }
    }
    freeDeviceTable(deviceInfo);
  }
  cmsLog_debug(“%s”, rutTCHGlobals_cmsstrerror(ret));
  return(ret);
}
```

The present invention thereby provides methods and apparatus for QoS activation by activating classifiers when their associated IP addresses are also activated. The solves, among other issues, the problems of efficient QoS activation and since prior networks lack the ability to dynamically activate QoS based on device presence, especially when some packets traversing the network contain time sensitive data.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method of quality of service (QoS) activation of customer premises equipment (CPE) associated with a network, comprising:
activating classifiers associated with a switch port in the CPE; and
determining when an associated IP address of the switch port is also activated, wherein the switch port classifier is activated only when the IP address of the switch port is also activated.

2. The method of claim 1, wherein the activating further comprises selecting a device table having the IP address of the port therein and selecting a QoS classifier from a table of QoS classifiers to determine whether the QoS classifier and the activated IP address of the port match.

3. The method of claim 2, wherein the activating further comprises activating the QoS classifier on the matched switch port.

4. The method of claim 3, wherein the activating further comprises determining whether all QoS activators in the table of QoS classifiers have been selected.

5. The method of claim 4, wherein the activating further comprises updating the device table.

6. The method of claim 5, wherein the updating comprises selecting IP addresses from a table of IP addresses to determine the switch port's IP address.

7. The method of claim 6, wherein the updating further comprises determining whether the switch port is connected to the determined IP address.

8. The method of claim 7, wherein the updating further comprises marking the determined IP address as active with the switch port and storing the active determination in a device table.

9. The method of claim 8, wherein the updating further comprises determining whether all IP addresses have been selected.

10. The method of claim 9, wherein the updating further comprises storing the active determination in a device table.

11. A customers premise equipment device (CPE), comprising:
a memory for storing tables associated with the CPE's quality of service (QoS) activation; and
a processor configured for activating classifiers associated with a switch port in the CPE, and determining when an associated IP address of the switch port is also activated, wherein the switch port classifier is activated only when the IP address of the switch port is also activated.

12. The CPE of claim 11, wherein the activating further comprises selecting a device table in the memory having the IP address of the port therein and selecting a QoS classifier from a table of QoS classifiers to determine whether the QoS classifier and the activated IP address of the port match.

13. The CPE of claim 12, wherein the activating further comprises activating the QoS classifier on the matched switch port.

14. The CPE of claim 13, wherein the activating further comprises determining whether all QoS activators in the table of QoS classifiers have been selected.

15. The CPE of claim 14, wherein the activating further comprises updating the device table in the memory.

16. The CPE of claim 15, wherein the updating comprises selecting IP addresses from a table of IP addresses in the memory to determine the switch port's IP address.

17. The CPE of claim 16, wherein the updating further comprises determining whether the switch port is connected to the determined IP address.

18. The CPE of claim 17, wherein the updating further comprises marking the determined IP address as active with the switch port and storing the active determination in the device table in the memory.

19. The CPE of claim 18, wherein the updating further comprises determining whether all IP addresses have been selected.

20. The CPE of claim 19, wherein the updating further comprises storing the active determination in the device table in memory.
